(19) United States
(12) Patent Application Publication
(10) Pub. No.: US 2007/0255011 A1
(43) Pub. Date: Nov. 1, 2007

(54) Polymeric Material Based On Propylene Or Ethylene With A Chlorinated Surface, Preparation And Uses

(75) Inventors: Michel Oulie, Valbeleix (FR); Alexis Braun, Coudes (FR)

Correspondence Address: OSHA LIANG L.L.P., 1221 MCKINNEY STREET, SUITE 2800, HOUSTON, TX, 77010, US

(73) Assignee: Valeo Systemes d'Essuyage, La Verriere (FR)

(21) Appl. No.: 11/597,000

(22) PCT Filed: May 23, 2005
(86) PCT No.: PCT/EP05/05558

§ 371 Date: Jun. 26, 2007

(30) Foreign Application Priority Data
May 25, 2004 (FR) 0405630

(51) Int. Cl. C08J 7/12; C08F 8/22

(52) U.S. Cl. 525/356

(57) ABSTRACT

The present invention concerns polymeric materials having propylene and/or ethylene motifs with a chlorinated surface, in particular materials used in the automotive industry, such as moulded products, and their applications in various other fields. It also deals with a method of preparing said materials.

The present invention concerns new materials containing polymers based on propylene and/or ethylene motifs with a chlorinated surface. These polymeric materials are in particular materials used in the automotive industry, such as moulded or extruded products, and their applications in various fields. It also deals with a method of preparing these polymers and these materials.

Many elastomers, such as EPDMs (ethylene propylene diene monomers), are used in the automotive industry. EPDMs, and other types of elastomer, have many advantages, such as chemical and physical inertia, characterised in particular by resistance to climatic changes, moisture and temperature variations. However, untreated moulded or extruded EPDMs, like other types of elastomer, have relatively high coefficients of friction which can be prohibitive for certain uses on account of their poor sliding properties. As EPDMs have a low unsaturation level (diene provided by a group such as norbornene is present in small quantities), the reaction methods for adding chlorine to the double carbon-carbon bonds conventionally applied to elastomers with a high unsaturation level do not, in the case of EPDMs, allow satisfactory coefficients of friction to be obtained. Thus, different techniques have been proposed to reduce this coefficient of friction, in particular by coating the surface of these elastomers with varnishes or incorporating therein lubricants (such as fluorinated polymers, graphite, molybdenum disulphide, talc, various oils, and reinforcing fibres). However, these products or these varnishes are expensive and add steps to the material preparation process.

Halogenation reactions in a solvent phase of EPDMs are furthermore described; these reactions however apply more particularly to a modification of the material in the latex state, and do not give said material any of the properties aimed for by the invention. Moreover, the use of solvents requires extensive equipment in order to remove the dangers of the operation and the pollution risks.

It would consequently be advantageous to provide a simple technique for reducing the coefficient of friction and/or increasing the surface tension of these elastomeric or plastic materials in order to thus make them usable in many fields.

These aims and others are achieved by the present invention which therefore proposes materials containing elastomeric or plastic polymers based on propylene and/or ethylene motifs, characterised in that at least some of said propylene and/or ethylene motifs present on the surface of said material are chlorinated.

Another object of the present invention is the method of preparing materials containing the polymers thus chlorinated, comprising the following steps: (i) taking either gaseous chlorine or a material containing elastomeric or plastic polymers based on propylene and/or ethylene motifs to a temperature sufficient to reach the energy level necessary for the reaction of substitution of at least one hydrogen atom present in said motifs by at least one chlorine atom, and (ii), simultaneously with or after step (i), placing said material in contact with said gaseous chlorine.

The polymeric materials according to the invention therefore have, on the surface and in particular solely on the surface (the surface being less than or equal to 12 μm thick), chlorine atoms that were substituted wholly or partially for the hydrogen atoms present on the propylene and/or ethylene sites of said polymers. As the chlorine atoms are strongly bonded to the carbonaceous chains of the polymers (in particular EPDMs) (valency bonds), the lowering of the coefficient of friction observed on the materials according to the invention has the advantage of being permanent, even in the case of washing with polar or non-polar solvents, alkanes, alkenes, alkynes, dilute strong acids and dilute strong bases.

The elastomeric or plastic polymers based on propylene and/or ethylene motifs used are generally polymers having propylene and/or ethylene units in their main chain.

The polymers based on propylene and/or ethylene contained in the materials according to the invention can have or not have hydrocarbon chains pendant to the main chain; these hydrocarbon chains can also have or not have functionalised groups. The polymers based on propylene and/or ethylene according to the invention can have cross-linking motifs that give the polymers a folding on themselves and/or form a network between several polymers.

The polymers based on propylene and/or ethylene can be of natural origin or advantageously of synthetic origin. They can possibly have, in particular on their main chain, monomeric units having unsaturated motifs (in particular of the double carbon-carbon bond type), such as in particular the monomer 5-ethylidene-2-norbornene, 1,4-pentadiene, 1,4-hexadiene, cyclohexadiene, 5-butylidene-2-norbornene and dicyclopentadiene. Preferentially, the proportion of monomers having unsaturated motifs in the polymers based on propylene and/or ethylene used in the present invention is less than or equal to 20% by weight.

There can be cited, by way of examples of elastomeric polymers based on propylene and/or ethylene motifs, EODMs (ethylene olefin diene monomers), in particular EPDMs, EOMs (ethylene olefin monomers; with no diene motif), more specifically EPMs (ethylene propylene monomers; with no diene motif) or EPTs (ethylene propylene terpolymers). EPDMs are more particularly used.

The elastomers used according to the present invention can be vulcanised or not and possibly protected by an antioxidant.

The EODMs used in the invention can be defined as elastomeric polymers with a low unsaturation level. They generally have ethylene monomers, at least one alpha-monoolefin having from 3 to 8 carbon atoms, such as propylene, 1-butene, 1-pentene, 1-hexene, 1-octene and 1-decene, etc. (preferably propylene), and an acyclic or alicyclic non-conjugated diene with a linear or branched chain (such as the monomers having unsaturated motifs identified above). EPDMs can be cited in particular. The EPDMs particularly adapted are those that contain 20-80% ethylene, 80-20% propylene and between 2% and 11% non-conjugated diene (% expressed by weight). Generally, the conjugated diene is a norbornene group.

There can be cited, by way of examples of plastic polymers based on propylene and/or ethylene motifs, the polypropylenes or the polyethylenes (in particular the high-density polyethylenes, also called HDPEs).

The materials containing the polymers based on propylene and/or ethylene motifs can also comprise other constituents, including in particular carbon black, oil, cross-linking agents, activators, such as zinc oxide, other metallic oxides, fatty acids, such as stearic acid, or their salts, fillers or reinforcing agents, such as calcium carbonate or magnesium carbonate, silica, silicates of aluminium, etc., plasticizers and UV stabilisers; anti-degradation agents; softening agents; waxes and pigments.

The materials can also contain, blended with the main matrix of polymers based on propylene and/or ethylene motifs (in particular EPDM type elastomeric polymers), other polymers, in particular natural or synthetic polymers with a high level of unsaturations (such as in particular ethylenic unsaturations), like for example natural or synthetic polyisoprene, polybutadiene, polychloroprene, styrenated polybutadiene (SBT) or nitrilated polybutadiene (NBR), etc. Of course, persons skilled in the art will make sure of the correct compatibility and quantity of these blends, and that they do not impair the properties desired within the context of the present invention.

The ratio by weight of the polymers based on propylene and/or ethylene motifs defined above and present in the material according to the invention is advantageously greater than or equal to 60%, in particular greater than or equal to 80%, with respect to the total weight of the material.

The maximum quantity of these polymers in the material can reach up to 100%.

When other unsaturated polymers are present in the material, the relative quantity of unsaturated polymers (in particular elastomers) is advantageously less than or equal to 40 parts per 100 parts of polymers present. Thus, the blend resulting therefrom can reach a relative proportion by weight of polymers (in particular elastomers) of 60% polymers based on propylene and/or ethylene motifs (in particular EPDM type elastomeric polymers) to 40% unsaturated polymers (in particular unsaturated elastomers).

The initial polymers used in the method according to the invention can be previously moulded, extruded or shaped by any other method known to persons skilled in the art. The polymers can be vulcanised or not. The methods of vulcanising the polymers are those commonly used (vulcanisation with sulphur, peroxide, etc.).

They can thus be in the form of windscreen wiper blades or any other form adapted to their subsequent use such as a seal, motor vehicle door glass weatherstrip, or motor vehicle door seal.

The method according to the invention therefore surprisingly and advantageously makes it possible to substitute hydrogen atoms present on the ethylene or propylene motifs of the polymers by chlorine atoms. The chlorination of these polymers makes it possible to lower the coefficient of friction of the materials containing said polymers and to increase their surface energy. Materials containing the polymers thus chlorinated have a reduced sticking effect and/or improved “barrier” properties (or sealing properties), which makes them more particularly usable as windscreen wiper blades, made from elastomer material, motor vehicle door window weatherstrips and seals, or as an interior coating (or to constitute the material) of petrol tanks.

The chlorine content present in the polymers of the materials according to the invention can vary to a great extent, in particular as a function of the physical parameters used (such as for example the temperature, pressure or reaction time with the chlorine). The chlorine content present in the polymers of the material according to the invention is advantageously greater than or equal to 8% in the first three microns of the surface of the material, preferably 10% (perhaps even 12%), expressed as an atomic percentage of chlorine/(sum of the chemical elements present). The maximum chlorine content fixed can vary according to the desired quality; it can for example reach values up to 20%, perhaps even 30%, in the first three surface microns, as an atomic percentage of chlorine/(sum of the chemical elements present). The chlorine content is measured using a scanning electron microscope by the EDS (Electronic Dispersive Spectrometry) method of JEOL 5310LV type (Energy 20 kV—high vacuum mode—sample preparation by deposition of a carbon layer—experimental conditions: magnification: X200—probe current: 1 nA—acquisition time: 400 sec—analyser: silicon-lithium). The chlorine content is determined using a calibrated NaCl standard.

According to step (i) of the method of the invention, the gaseous chlorine and/or the elastomeric or plastic polymers based on propylene and/or ethylene motifs are taken to a temperature sufficient to reach the energy level necessary for the reaction of substitution of at least one hydrogen atom present in said motifs by at least one chlorine atom.

According to a preferred variant of step (i), it is the elastomeric or plastic polymers based on propylene and/or ethylene motifs which are taken to a temperature sufficient to reach the energy level necessary for the reaction of substitution of at least one hydrogen atom present in said motifs by at least one chlorine atom. In this case, the gaseous chlorine can be heated or not, and therefore advantageously kept at ambient temperature (between approximately 18° C. and 25° C.).

According to another variant of step (i), the chlorine gas is taken to a temperature sufficient to reach the energy level necessary for the reaction of substitution of at least one hydrogen atom present in said motifs by at least one chlorine atom. As the chlorine gas has a thermal capacity generally lower than the polymers, the chlorination reaction time of step (ii) is, according to this variant, generally longer in order to reach satisfactory chlorination levels. The elastomeric or plastic polymers based on propylene and/or ethylene motifs can be heated or not, in this case.

The temperature sufficient to reach the energy level necessary for the reaction of substitution of a hydrogen atom present in said motifs by a chlorine atom from the chlorine gas is one form of energy allowing the chlorination reaction to take place. This thermal energy can be partially or totally replaced by another energy source, such as in particular the energy supplied by electromagnetic radiation. The energy applied allows in particular the polymers and/or the chlorine gas to reach the activation energy threshold necessary for the chlorination reaction. The energy can in particular come from ultraviolet radiation (more specifically through a reactor with a quartz wall transparent to radiation of wavelength less than or equal to 400 nm). The reaction can also be initiated (and carried out) by introduction of chlorine into a gaseous plasma; the energy released by the plasma makes it possible to obtain radical chlorine atoms capable of grafting onto the saturated carbons of the methyl functions of the propylene and/or ethylene motifs.

The products heated at step (i) can be heated by infrared, microwaves or any other means known to persons skilled in the art. Heating by infrared can be carried out through a glass wall of a reactor where the reagents to be heated are located.

According to the method of the invention, the placing of the polymers in contact with the gaseous chlorine is carried out en masse (in the absence of solvent). In practice, this placing in contact can be carried out by immersing the polymers in a bath of gaseous chlorine or by circulating gaseous chlorine in a device where the polymers are situated.

The gaseous chlorine used in the method according to the invention can be pure or diluted in any proportion in another gas, such as nitrogen, oxygen, or any other gas compatible with chlorine and inert as regards the reaction. The chlorine gas can advantageously be drawn off a reserve of liquid chlorine, or generated using chemical reactions of the manganese dioxide and hydrochloric acid type.

The temperature sufficient to reach the energy level necessary for the reaction of substitution of a hydrogen atom present in said motifs by a chlorine atom of the chlorine gas can vary according to the polymers used. However, to give an order of magnitude, this temperature is generally greater than or equal to 100° C. (or 110° C., perhaps even 120° C.) for elastomeric polymers, or greater than or equal to 80° C. (or 90° C, perhaps even 100° C.) for plastic polymers. Advantageously, the temperature is less than the decomposition or melting temperature of the polymers. This temperature varies according to the nature of the polymer. Thus, for example, the start-of-decomposition temperature of EPDMs or EPMs is approximately 240° C., the melting temperature of polypropylene is approximately 145° C. and that of polyethylene is from 90° C. to 110° C. (according to the molecular weight).

According to a preferred mode of step (i) of the method, EPDMs are taken to a temperature of between 130° C. and 220° C., in particular between 135° C. and 215° C., perhaps even between 140° C. and 180° C.

According to another preferred mode of step (i) of the method, EPMs are taken to a temperature of between 150° C. and 210° C., in particular between 155° C. and 215° C., perhaps even between 160° C. and 210° C.

The pressure of the method according to the invention (steps (i) and/or (ii)) is generally and advantageously atmospheric pressure. Of course, if the pressure is higher or lower than atmospheric pressure, the heating temperature of step (i) and the reaction time are modified accordingly, in particular so as to reach the activation energy threshold specified above. A lower pressure must be compensated for by a longer reaction time and/or a higher temperature. On the contrary, a high pressure makes it possible to reduce the reaction time and the temperature.

The reaction time of step (ii) varies as a function of the other physical and chemical parameters used. It also depends on the depth and density of chlorination (of the chlorination sites) desired and sought for the polymers. To give an order of magnitude, the time can vary between 1, preferably 5, seconds, when the activation temperature is reached or exceeded, up to a few minutes (advantageously one minute), when the temperature is a few degrees below the activation temperature.

The method according to the invention is implemented in a device adapted to the steps identified above. It can in particular be carried out in a tubular reactor equipped with diaphragms at the ends, and in which there circulates the profile (or material) to be treated taken to the required temperature.

The materials according to the invention which have an increased surface tension and a reduced coefficient of friction can thus be used in a wide range of applications and in particular in the automotive industry, aeronautics and the construction industry. The materials according to the invention can be moulded and used as seals, in particular door or window seals, profiles (in particular in the construction industry), cables, pipes, catheters, or also shoes, gloves or boots. They can also be used, as specified above, as an internal coating or constitute the material of tanks for petrol or for any other petroleum product used for engines. Finally, they can be used as windscreen wiper blades.

Thus, the improved surface tension and reduced coefficient of friction prevent doors and windows from sticking at the moulded part and facilitate retraction of the glass or any other material liable to stick on the moulded elastomer surfaces. The reduced coefficient of friction prevents for example the squealing noises of the “weatherstrips” when the windows of motor vehicle doors are raised or lowered and reduces the power (and therefore the cost) of motors associated therewith. In the case of windscreen or headlight wiper blades, these properties make it possible to have the advantages of sliding of the blades made from chlorinated elastomers with a high unsaturation level, whilst not having their possible drawbacks, namely in particular the appearance of cracks over time or as a function of climatic conditions.

Another object of the present invention is therefore materials or devices comprising (or consisting of) the polymers thus chlorinated. These materials or devices are in particular seals, preferentially door or window seals, marine or aeronautical portholes, motor vehicle door window weatherstrips, profiles, cables, pipes, catheters, shoes, boots, internal coatings of tanks for petrol or for any other petroleum product used for engines, or windscreen or headlight wiper blades.

Other aspects and advantages of the present invention will emerge from a reading of the following examples, which must be considered as illustrative and not limiting.

### EXAMPLES

Elastomer of the EPDM type is raised to a temperature of 160° C. sufficient to reach the energy level necessary for the hydrogen atom substitution reaction, and then immersed in a tubular glass reactor with a diameter 2 to 3 times greater than that of the profile (or component) to be treated and containing gaseous chlorine at atmospheric pressure, for 5 seconds. The chlorine gas is drawn off from a reserve of liquid chlorine, or generated using chemical reactions of the manganese dioxide and hydrochloric acid type. The gas is introduced at the reactor base under the simple effect of its partial pressure so as to drive out the air by density difference. The thermal energy supplied by the elastomer is communicated to the chlorine atoms situated in the vicinity of the surface, thus allowing the reaction of substitution of the hydrogen of the propylene (or ethylene) group by the chlorine atom. When the 5 seconds have elapsed, the profile (or component) is removed from the reactor and cooled.

Effects Measured:

The coefficient of friction of the EPDM/glass is lowered and values of 1.2 are commonly obtained with wiper blades but values of 1.0 can be achieved. The measurements were made on plate glass (on the “float” side) at a speed of 300 mm/sec for loads of approximately 0.15 N/cm.

The chlorine content is measured at the surface of the polymers by EDS (Electronic Dispersive Spectrometry) of the JEOL 5310LV type (Energy 20 kV—high vacuum mode—sample preparation by deposition of a carbon layer—experimental conditions: magnification: X200—probe current: 1 nA—acquisition time: 400 sec—analyser: silicon-lithium). The chlorine content is determined using a calibrated NaCl standard.

The conventional liquid or gaseous halogenation methods give a chlorine content expressed as an atomic ratio of chlorine/(chlorine+carbon) of 7% in the first three surface microns for an EPDM of the BUNA 3850 type at 8% ENB (Ethylene NorBornene) marketed by the Bayer company.

In the case of the homolytic radical chlorination according to the invention, the chlorine content reached 20%, expressed as an atomic % of chlorine/(sum of all the chemical elements present) in the first three surface microns, and is accompanied by a large reduction in the coefficient of friction and the absence of a sticky feel.

After treatment according to the invention, cleaning or brushing of the surface with water, detergents or solvents (polar or non-polar) neither decreases the chlorine content fixed, nor modifies the coefficient of friction, proving that the chlorine is chemically bonded with the material and not simply absorbed at the surface. In the case of vulcanised EPDMs, containing unsaturated constituents at the surface capable of bonding with the chlorine, cleaning of the surface did not lead to any modification of the chlorine content, proving that the chlorine is bonded with the carbonaceous chain of the EPDM. A slight increase in the chlorine content after cleaning with solvents was even measured, due to the elimination of products forming a barrier to the X-rays of the EDS analyser.

The EPDM material is neither modified nor impaired in its body; the treatment does not go beyond about ten micrometres in depth.

In the case of the treatment according to the invention, observation at high magnification did not reveal the cracking phenomenon often present on chlorinated dienic elastomers.

The surface energy (interfacial tension) is greatly increased, allowing good adhesion of coatings, glues, inks, etc.

According to the measuring method referred to as “surface wetting” using liquids with known surface tensions covering the surface energy range to be measured: Untreated material: surface tension=50 mN/m

After chlorination according to the invention: surface tension=70 mN/m The number of methyl functions of the propylene or ethylene motifs substituted by chlorine atoms is a function of the energy (thermal, etc.) and of the polymer/gas contact time.

In the case of EPDM thermal activation (thermolysis), the temperature is greater than 160° C. (at atmospheric pressure). The time is greater than or equal to 2 seconds.

Example Value Obtained on an EPDM (Identical to the Preceding One) Vulcanised With Sulphur:

Temperature of the elastomer 170°-180° C., immersion in pure chlorine gas at atmospheric pressure for 3 to 5 seconds.

The chlorine content is measured on the surface of the polymers by EDS (Electronic Dispersive Spectrometry) of the JEOL 5310LV type (Energy 20 kV—high vacuum mode—sample preparation by deposition of a carbon layer—experimental conditions: magnification: X200—probe current: 1 nA—acquisition time: 400 sec—analyser: silicon-lithium). The chlorine content is determined using a calibrated NaCl standard.

Cl fixed: 17% to 20% expressed as an atomic % of chlorine/sum of all chemical elements present in the first three surface microns.

Example Value on an EPDM (Identical to the Previous One) Vulcanised With Peroxides:

Temperature of the elastomer 180°-190° C., immersion in pure chlorine gas at atmospheric pressure for 3 to 5 seconds.

The analysis conditions are as specified above.

Cl fixed: 18% to 20% expressed as chlorine/sum of all the chemical elements present in the first three surface microns.

Example Values on Vulcanisates Based on EP(D)M Containing Different Proportions of Ethylene, Propylene and Diene.

Within the context of this experiment, four formulations were produced. The characteristics of the elastomers used are as follows. The percentages are expressed as relative weight of the motif considered with respect to the weight of the total polymer.

TABLE 1

| | | | | Mooney |
|---|---|---|---|---|
| EP(D)M | Ethylene (%) | Propylene (%) | ENB (%) | viscosity |
| Buna 6470 | 68 | 27.5 | 4.5 | 55 ML (1 + 8) |
| | | | | 125° C. |
| Buna 3440 | 48 | 48 | 4 | 28 ML (1 + 4) |
| | | | | 125° C. |
| Buna 3850 | 48 | 44 | 8 | 28 ML (1 + 4) |
| | | | | 125° C. |
| Buna 2050 | 52 | 48 | 0 | 24 ML (1 + 4) |
| | | | | 125° C. |

ML: consistometric index unit - 1 Mooney point = 0.083 N.m.
The vulcanisates in the form of moulded plates are prepared according to the following formulations. Vulcanisates 1, 2, 3 and 4 correspond to the materials containing respectively Buna 6470, 3440, 3850 and 2050.

TABLE 2
(resulting vulcanisates)

| | | | Peroxide (DBPH) |
|---|---|---|---|
| | | Carbon black | (2,5-Bis(tert-butylperoxy)-2,5 |
| Constituents | EP(D)M (pce) | Grade N550 (pce) | dimethylhexane) (pce) |
| Vulcanisate 1 | 100 | 20 | 3 |
| Vulcanisate 2 | 100 | 20 | 3 |
| Vulcanisate 3 | 100 | 20 | 3 |
| Vulcanisate 4 | 100 | 20 | 3 |

pce: part in percentage weight of elastomer
Rectangular test pieces of 100 × 20 × 2 mm are cut out of the vulcanisate plates.

Chlorination of the vulcanisates is carried out in a glass tube supplied with gaseous chlorine at atmospheric pressure. The vulcanisates are heated by infrared. Three heating temperatures were applied: 135° C., 165° C. and 215° C. The length of stay in the reactor is 4 seconds.

The chlorine content results, obtained as a % (ratio of chlorine/sum of all the chemical elements present) and analysed under conditions identical to those stated above, are presented in the following table.

TABLE 3
(values of the chlorine contents obtained as a function of the
temperatures applied)

| Temperature | 135° C. | 165° C. | 215° C. |
|---|---|---|---|
| Vulcanisate 1 | 5% | 9% | 25% |
| Vulcanisate 2 | 5% | 9% | 23% |
| Vulcanisate 3 | 5% | 10% | 22% |
| Vulcanisate 4 | 3% | 10% | 25% |

At 135° C., the chlorination values obtained do not give rise to an appreciable reduction in the coefficient of friction. Within the context of this example, the optimum chlorination for an adapted surface modification is obtained for a temperature of between 165° C. and 215° C.

1. A material comprising elastomeric polymers based on propylene and/or ethylene motifs, chosen from amongst EODMs, EOMs and EPTs, wherein at least some of said propylene and/or ethylene motifs present on the surface of said material are chlorinated.

2. The material according to claim 1, wherein the polymers also have monomeric units having unsaturated motifs (in particular of the double carbon-carbon bond type), such as in particular the monomer 5-ethylidene-2-norbornene, 1,4-pentadiene, 1,4-hexadiene, cyclohexadiene, 5-butylidene-2-norbornene and dicyclopentadiene.

3. The material according to claim 1, wherein the EODM or EOM elastomeric polymers based on propylene and/or ethylene motifs are EPDMs or EPMs.

4. The material according to claim 1, wherein the polymers are EPDMs.

5. The material according to claim 4, wherein the EPDMs contain 20%-80% ethylene motifs, 80%-20% propylene motifs and between 2% and 11% non-conjugated diene by weight.

6. The material according to claim 5, wherein the diene is a norbornene group.

7. The material according to claim 1, wherein it also comprises other polymers, in particular natural or synthetic polymers with a high level of unsaturations.

8. The material according to claim 7, wherein the relative quantity of said unsaturated polymers is less than or equal to 40 parts per 100 parts of polymers present.

9. The material according to claim 1, wherein the chlorine content present is greater than or equal to 8%, preferably 10%, in the first three microns of the surface of the material.

10. The material according to claim 1, wherein the maximum chlorine content measured in the first 3 microns of the surface of the material is 30%.

11. A method of preparing polymeric material according to claim 1, wherein it comprises the following steps:
(i) taking either gaseous chlorine or the material containing elastomeric polymers based on propylene and/or ethylene motifs, chosen from amongst EODMs, EOMs and EPTs, to a temperature sufficient to reach the energy level necessary for the reaction of substitution of at least one hydrogen atom present in said motifs by at least one chlorine atom, and
(ii), simultaneously with or after step (i), placing said polymers of the material in contact with said gaseous chlorine.

12. (canceled)

13. The method according to claim 11, wherein the polymers used at step (i) are previously moulded, extruded, and vulcanised.

14. The method according to claim 11, wherein said polymers are taken to a temperature sufficient to reach the energy level necessary for the reaction of substitution of at least one hydrogen atom present in said motifs by at least one chlorine atom.

15. The method according to claim 11, wherein the thermal energy applied at step (i) is partially or totally replaced by another energy source, such as the energy supplied by electromagnetic radiation.

16. The method according to claim 11, wherein the products heated at step (i) can be heated by infrared or microwaves.

17. The method according to claim 11, wherein the temperature of step (i) is greater than or equal to 100° C. (or 110° C., perhaps even 120° C.) for elastomeric polymers.

18. The method according to claim 11, wherein the temperature of step (i) is less than the decomposition or melting temperature of the polymers used.

19. The method according to claim 11, wherein EPDMs are taken to a temperature of between 130° C. and 220° C., in particular between 135° C. and 215° C., perhaps even between 140° C. and 180° C.

20. The method according to claim 11, wherein EPMs are taken to a temperature of between 150° C. and 210° C., in particular between 155° C. and 215° C., perhaps even between 160° C. and 210° C.

21. The method according to claim 11, wherein the placing of the polymers in contact with the gaseous chlorine of step (ii) is carried out en masse.

22. The method according to claim 11, wherein the placing of the polymers in contact with the gaseous chlorine of step (ii) is carried out by immersing the polymers in a bath of gaseous chlorine or by circulating gaseous chlorine in a device where the polymers are situated.

23. A method of preparing material, containing elastomeric or plastic polymers having propylene and/or ethylene motifs, some of said propylene and/or ethylene motifs present on the surface of said material being chlorinated, wherein it consists of the following steps:
(i) taking either gaseous chlorine or a material containing said elastomeric or plastic polymers based on propylene and/or ethylene motifs to a temperature sufficient to reach the energy level necessary for the reaction of substitution of at least one hydrogen atom present in said motifs by at least one chlorine atom, and
(ii), simultaneously with or after step (i), placing said polymers of the material in contact en masse with said gaseous chlorine.

24. The method according to claim 23, wherein the plastic polymers based on propylene and/or ethylene motifs are polypropylenes or polyethylenes.

25. The material according to claim 1, used as seals, in particular door or window seals, profiles, motor vehicle door window weatherstrips, motor vehicle door seals, cables, pipes, catheters, shoes or boots, gloves, internal coating or material of tanks for petrol or for any other petroleum product used for engines, or windscreen or headlight wiper blades.

26. (canceled)
